(19) United States
(12) Patent Application Publication
(10) Pub. No.: US 2015/0315896 A1
(43) Pub. Date: Nov. 5, 2015

(54) Scale Indication Device and Method

(71) Applicant: SCALE PROTECTION AS, Harstad (NO)

(72) Inventor: Ole Magnar DRØNEN, Harstad (NO)

(73) Assignee: SCALE PROTECTION AS, Harstad (NO)

(21) Appl. No.: 14/650,455

(22) PCT Filed: Jan. 2, 2013
(86) PCT No.: PCT/NO2013/050002

§ 371 Date: Jun. 8, 2015

(51) Int. Cl. E21B 47/00; G01F 1/74

(52) U.S. Cl. CPC E21B 47/00; G01F 1/74

(57) ABSTRACT

A scale indicator is for a flowline for a fluid. At least one partial fluid line which is arranged to carry a partial fluid flow is provided with an inlet port arranged upstream in a main fluid flow and an outlet port arranged downstream in the main fluid flow. The at least one partial fluid line contains a tracer depot which is in fluid communication with the partial fluid flow. A method is for monitoring a scaling state in a flowline.

### CROSS-REFERENCE TO RELATED APPLICATIONS

This application is the U.S. national stage application of International Application PCT/NO2013/050002, filed Jan. 2, 2013, which international application was published on Jul. 10, 2014, as International Publication WO2014/107113 in the English language. The international application is incorporated herein by reference, in entirety.

### FIELD

A scale indicator for a flowline for a fluid is described, in which, more precisely, at least one partial fluid line which is arranged to carry a partial fluid flow is provided with an inlet port arranged upstream in a main fluid flow and an outlet port arranged downstream in the main fluid flow. A method of monitoring a scaling state in a flowline is described as well.

### BACKGROUND

In production wells for hydrocarbons, the formation of mineral scaling constitutes a problem as the scaling results in the flow capacity of pipes, ports, filters, perforations etc. being considerably reduced as the scaling builds up. The type of scaling contributing to the greatest extent to the problem arises when injected sea water is mixed with reservoir water. Barium ions (Ba²⁺) dissolved in the formation water react with sulphate ions (SO₄²⁻) dissolved in the sea water and form barium sulphate (BaSO₄).

The development of scale is not always predictable, and there is a need for improving the quality and the reliability of the monitoring of the wells, so that necessary action may be taken before the development has gone too far.

From the prior art, it is known to do chemical analyses of the production water from the well in question. These measuring results may indicate that scaling is going on, but not whether this is happening in the reservoir, where the consequences are limited, or in the production equipment, where protection against scaling is necessary.

The production development may be used as n indicator of adverse scaling in production equipment. However, the drawback is that the scaling downhole has already developed to a harmful level before it has been possible to take necessary action, and the well may already have suffered irreparable damage.

The problems that have been described above for a well could also occur in other parts of a production system for hydrocarbons. In the further description, unless something else has explicitiy been mentioned, the term “well” will also include other installations in which the build-up of scale or other types of precipitations may cause reduction in a flow capacity.

By the terms “scaling” and “scale” are also meant forms of clogging of a fluid flow path other than the chemically induced formation of solids mentioned, for example precipitation, the formation of wax and ice, the formation of hydrates, the sedimentation of solid particles and so on.

From EP 0622630 A2, a system and a method for optimizing the dosing of a scale inhibitor are known, wherein a sensor for heat transfer rate or heat transfer resistance through a contact surface which is in contact with water in a water circulation system is connected to a monitor, and a first temperature modulator is arranged near the contact surface to maintain a temperature that encourages scaling. Reading values for heat transfer rate or heat transfer resistance are used as indicators of scaling to see whether the desired conditions for scale inhibition have been achieved, in order there-by to control the supply of the scale inhibitor.

US 2008163700 A1, U.S. Pat. No. 6,880,402 B1 and US 2003071988 A1 disclose other examples of devices and methods for detecting scale on the internal walls of a pipe by the use of either thermal, acoustic or ultrasonic methods.

From the applicant's own patent application NO 20100557, a scale indicator for a flow-line for a fluid is known, characterized by a partial fluid line, which is arranged to carry a partial fluid flow, being provided with means arranged to provide and register a differential temperature between a partial fluid flow through the partial fluid line and a main fluid flow. The document also discloses a method of monitoring a scaling state in a flowline.

### SUMMARY

The invention has for its object to remedy or reduce at least one of the drawbacks of the prior art or at least provide a useful alternative to the prior art.

The object is achieved through features which are specified in the description below and in the claims that follow.

In a fluid flowline, at least one partial fluid line is arranged, provided with an amount of a tracer, preferably in solid form, arranged in a depot which is in fluid communication with a partial fluid flow. The partial fluid line has an upstream inlet port, and said partial fluid flow which is directed into the partial fluid line, where it picks up and carries along some of the tracer, mixes with a main fluid flow as the partial fluid flow leaves the partial fluid line through an outlet port located downstream. By analytical methods known per se, the tracer may be found in the fluid flow downstream of the partial fluid line. With scaling around and in the inlet port, the partial fluid flow will decrease, and this will have an effect on the amount of tracer in the fluid flow downstream of the partial fluid line. The amount of tracers that are found in the fluid flow may therefore be an indicator of the scaling state in the area in which the partial fluid line is located, by the very fact of the partial fluid flow being affected by scale at the inlet port.

By the use of several partial fluid lines provided with different tracers and with different inlet port characteristics, finding the different tracers in the fluid flow may give an indication of the degree of scaling.

The partial fluid line may be formed as a side pocket in the flowline, but it may also be placed directly in the flowline. In a practical embodiment of the invention, the partial fluid line will be arranged in a pipe section (a so-called sub) for quick assembling and disassembling relative to a pipe string, for example a production tubing string in a hydrocarbon well.

To encourage scaling at the partial fluid line(s), scale-increasing means may appropriately be provided at the inlet port(s), typically turbulence-encouraging means and the use of materials encouraging scaling. The materials may be of a type and/or provided with a surface which is scale-encouraging in itself.

In a first aspect, the invention more specifically relates to a scale indicator for a flow-line for a fluid in a hydrocarbon well or a production system for hydrocarbons, in which at least one partial fluid line which is arranged to carry a partial fluid flow is provided with an inlet port arranged upstream in a main fluid flow and an outlet port arranged downstream in the main fluid flow, characterized by the at least one partial fluid line containing a tracer depot which is in fluid communication with the partial fluid flow.

The inlet port of a partial fluid line may exhibit fluid-flow characteristics that differ from the fluid-flow characteristics of the inlet port of each of the other partial fluid line(s), and the contents of the tracer depot of one partial fluid line are different from the contents of the tracer depots of each of the other partial fluid line(s).

The partial fluid line may be arranged in a side pocket in a pipe section.

The highest flow rate of the partial fluid flow may be substantially lower than the flow rate of the main fluid flow.

At the inlet port arranged upstream, turbulence-amplifying means may have been formed.

At least a portion of the partial fluid hoe surrounding the inlet may be formed of a material with scale-increasing properties.

The scale-increasing material may be copper.

The scale-increasing material may have a rough surface.

In a second aspect, the invention relates to a method of monitoring a scaling state in a flowline for a fluid in a hydrocarbon well or a production system for hydrocarbons, the method including the step of:
carrying a partial fluid flow through a partial fluid line from an inlet port arranged upstream in a main fluid flow to an outlet port arranged downstream in the main fluid flow,

characterized by the method including the further steps of
bringing the partial fluid flow into contact with a tracer depot which is arranged in the partial fluid line;
monitoring the tracer content in the main fluid flow downstream of the outlet from the partial fluid line; and
by means of a change in the tracer content, calculating a change in the flow rate of the partial fluid flow and thereby simulating the scaling state of the flowline at the partial fluid line.

### BRIEF DESCRIPTION OF THE DRAWINGS

In what follows, an example of a preferred embodiment is described, which is visualized in the accompanying drawings, in which:

FIG. 1 shows a longitudinal section through a scale indicator arranged for a flowline forming a production tubing in a well, the scale indicator being arranged in pockets in the flowline; and

FIG. 2 shows a longitudinal section through an alternative embodiment of a scale indicator, in which one partial fluid line is arranged in the main bore of the flowline.

### DETAILED DESCRIPTION OF THE DRAWINGS

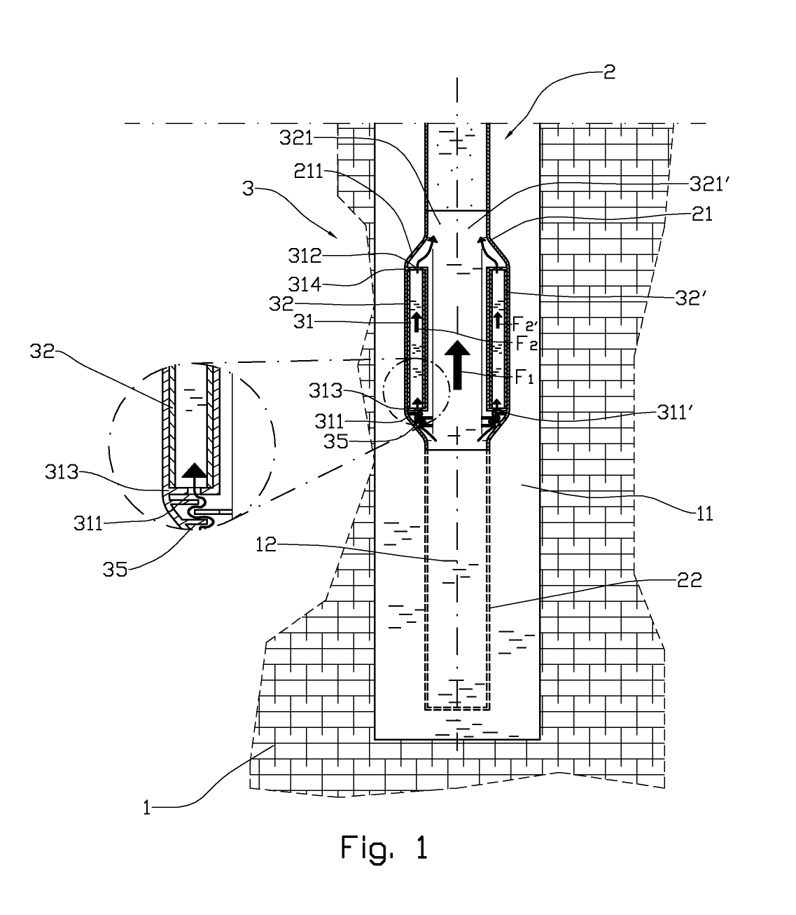

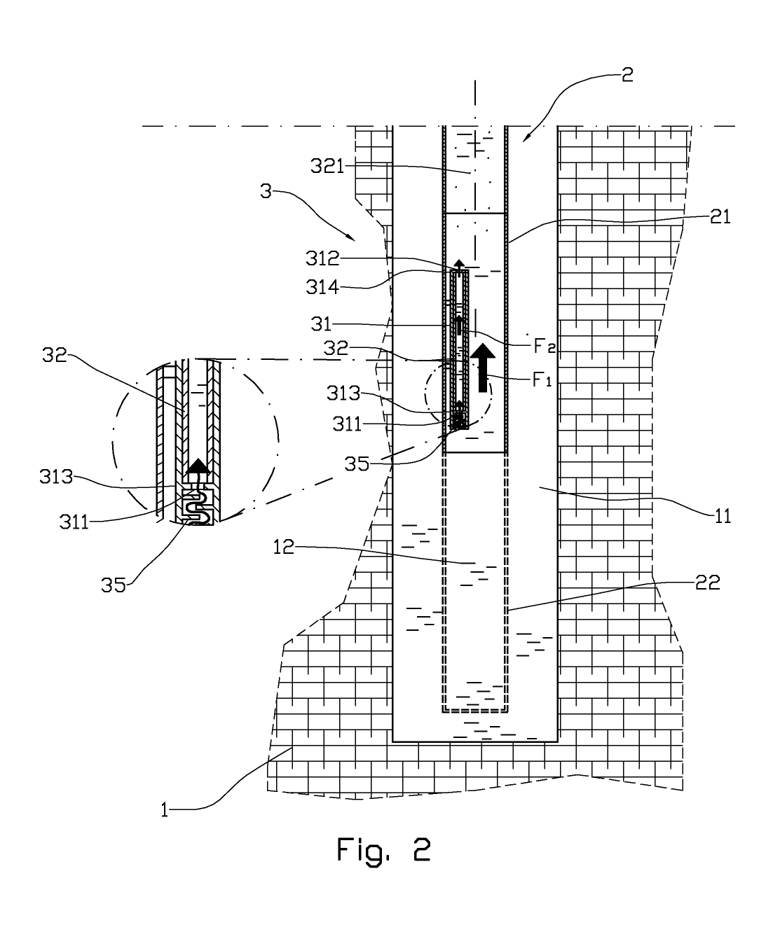

In the drawings, the reference numeral 1 indicates an underground structure including a borehole 11 which forms a well from which a well fluid 12 is produced through a flowline 2. In a portion of the flowline 2, a scale indicator 3 is arranged, shown in FIG. 1 in pockets in a pipe section 21 and, in FIG. 2, arranged in the flow path of the pipe section 21.

In a manner known per se, the flowline 2 is provided with means for controlling the inflow of well fluid, shown schematically in the figures as a perforated downhole section 22.

The scale indicator 3 is formed of at least one partial fluid line 31 in the form of a container with a fluid inlet port 311 arranged upstream in a first end portion 313 of the container 31 and an outlet port 312 arranged downstream in a second end portion 314 of the container 31. The inlet port 311 and the outlet port 312 exhibit a flow area which provides a partial fluid flow F₂ with a flow rate substantially lower than the flow rate of a main fluid flow F₁ in the flowline 2. For practical purposes, it is favourable that the outlet port 312 is substantially larger than the inlet port 311, so that the partial fluid flow F₂ is not restricted by the size of the outlet port 312.

In FIG. 1, two partial fluid lines 31 are shown, whereas FIG. 2 shows one partial fluid line 31.

Upstream of the inlet 311, means 35 are arranged, also called a turbulence amplifier, arranged to provide a turbulent fluid flow towards the inlet port 311.

In the partial fluid line(s) 31, a tracer depot 32 is arranged, which is in direct contact with the partial fluid flow F₂.

As the partial fluid flow F₂ passes the tracer depot 32, an amount of tracer 321 is released into the partial fluid flow F₂. This release of tracer 321 depends on the flow rate of the partial fluid flow F₂. The partial fluid flow F₂ passes out of the partial fluid line(s) 31 through the outlet port(s) 312 and mixes with the main fluid flow F₁. When the main fluid flow rate and the flow characteristics of the inlet port(s) 311 are known, the amount of tracer 321 found in the main fluid flow F₁ may thereby be used to determine the partial fluid flow rate. From this, it will be possible to calculate the actual size of the of the inlet port 311. The amount of tracer 321 in the main fluid flow F₁ can thereby be used as a scale indicator.

Reference is now made to FIG. 1 in particular. By the use of several partial fluid lines 31 having different maximum flow rates by the partial fluid lines 31 being provided with different-size inlet ports 311, 311′ and by the tracer depots 32, 32 containing different tracers 321, 321, the release of tracers 321, 321′ into the different partial fluid flows F₂, F₂ will give an indication of how the scaling is developing.

For most substances, for example sulphate salts, which are dominant in this sphere, turbulence will increase the scaling tendency. Said turbulence amplifier 35 increases the scaling tendency at the inlet port(s) 311, possibly 311′.

By forming at least parts of the first end portion 313, for example an annular portion surrounding the inlet port(s) 311, possibly 311′, of a material which increases the scaling tendencies, the risk of scaling may be detected more quickly. It is known that copper has such properties. A rough material surface could also increase the scaling tendencies, and it will be beneficial to form the inlet port(s) 311, possibly 311, with a rough surface on the side wall(s).

1. A scale indicator for a flowline for a fluid in a hydrocarbon well or a production system for hydrocarbons, the scale indicator comprising: at least one partial fluid line arranged to can a partial fluid flow, the at least one partial fluid line having an inlet port arranged upstream in a main fluid flow and an outlet port arranged downstream in the main fluid flow, wherein the at least one partial fluid line contains a tracer depot which is in fluid communication with the partial fluid flow.

2. The scale indicator according to claim 1, wherein the inlet port of the at least one partial, fluid line exhibits fluid flow characteristics that differ from the fluid flow characteristics of other inlet ports of other fluid line(s), and the contents of the tracer depot of the at least one partial fluid line are different from the contents of the tracer depots of other partial fluid line(s).

3. The scale indicator according, to claim 1, wherein a partial fluid line is arranged in a side pocket in a pipe section.

4. The scale indicator in accordance with claim 1, wherein the highest flow rate of the partial fluid flow is substantially lower than the flow rate of the main fluid flow.

5. The scale indicator according to claim 1, wherein, at the inlet port arranged upstream, turbulence-amplifying means have been formed.

6. The scale indicator in accordance with claim 1, wherein at least a portion of the partial fluid line surrounding the inlet is formed of a material with scale-increasing properties.

7. The scale indicator in accordance with claim 6, wherein the scale-increasing material is copper.

8. The scale indicator in accordance with claim 6, wherein the scale-increasing material has a rough surface.

9. A method of monitoring a scaling state in it flowline for a fluid in a hydrocarbon well or a. production system for hydrocarbons, the method comprising:
carrying a partial fluid flow through a partial fluid line from an inlet port arranged upstream in a main fluid flow to an outlet port arranged downstream in the main fluid flow;
bringing the partial fluid flow into contact with a tracer depot which is arranged in the partial fluid line;
monitoring the contents of tracer in the main fluid flow downstream of the outlet from the partial fluid line; and
with a change in the contents of tracer, calculating a change in the flow rate of the partial fluid flow and thereby simulating the scaling state of the flowline at the partial fluid line.
